(19) United States
(12) Patent Application Publication
(10) Pub. No.: US 2025/0303774 A1
(43) Pub. Date: Oct. 2, 2025

(54) VALUE DOCUMENT WITH LUMINESCENCE FEATURE, VALUE DOCUMENT SYSTEM, PRODUCTION METHOD AND CHECKING METHOD

(71) Applicant: GIESECKE+DEVRIENT CURRENCY TECHNOLOGY GMBH, Munchen (DE)

(72) Inventors: Thomas HAPP, Munchen (DE); Wolfgang DECKENBACH, Schechen (DE)

(21) Appl. No.: 18/864,591

(22) PCT Filed: May 10, 2023
(86) PCT No.: PCT/EP2023/025223

§ 371 Date: Nov. 11, 2024

(30) Foreign Application Priority Data
May 11, 2022 (DE) 10 2022 001 659.1

(51) Int. Cl. B42D 25/328; B42D 25/29

(52) U.S. Cl. CPC B42D 25/328; B42D 25/29

(57) ABSTRACT

A flat document of value has a surface area having a longitudinal direction and a transverse direction and which is provided with a luminescence feature in the surface area. The luminescence feature includes a first luminescence marker in a first subarea and a second luminescence marker in a second, different subarea. The first and second luminescence markers are able to be excited to luminesce at the same wavelength and luminesce, after excitation, essentially in the same emission band in the infrared spectral range. The first and second luminescence markers have spectrally similar infrared emission spectra, namely infrared emission spectra that have a spectral difference between 0.5% and 15%. The first and second subarea are arranged so as to overlap one another in the surface area in projection onto the longitudinal direction and/or in projection onto the transverse direction.

### BACKGROUND

The invention relates to a document of value having a luminescence feature, and relates in particular to a flat document of value, such as a banknote, which has a surface area having a longitudinal direction and a transverse direction and which is provided with a luminescence feature in the surface area. The invention also relates to a document of value system consisting of a plurality of different such documents of value, to a method for manufacturing such a flat document of value and to a method for checking such a flat document of value.

In order to safeguard documents of value and check their authenticity or classify them, it is known for machine-checkable, in particular optically checkable security features to be introduced into and/or applied to the documents of value. These features may for example be luminescence features or luminescence markers, with luminescence features that are often invisible to the human eye and emit in the infrared (IR) spectral range being used as hidden security features.

In the authenticity check or classification, a document of value is illuminated for example with excitation light by a sensor and the light emitted by the document of value in response is captured in order to capture characteristic properties of the feature or a feature intensity. The captured properties are then compared to reference or threshold values in order to assign the feature, and thus the document of value, to a class. By way of example, in the case of an authenticity check, the document of value may be assigned to one of the classes “authentic” or “suspected counterfeit”.

It is known to add luminescence features during the production of a document of value in the form of powdered substances or pigments to a semi-finished product, for example a paper pulp, a master batch/polymer melt, or an ink, a clear lacquer or a color concentrate. The semi-finished product is further processed for example in the form of a pulp, a document of value substrate in the form of a web or sheet, a printed product in the form of a web, a sheet or a single blank, a foil element, for example a patch, a thread, a foil strip or planchettes, a fiber or an ink or a color concentrate, to produce the finished document of value. In particular, a luminescent feature powder may be added to an ink, and an imprint on a document of value substrate may thus be produced.

Combinations of different luminescent substances may be used to create individual codings for different classes of documents of value.

In order to be able to create exclusive coding classes here, that is to say to be able to reliably separate different documents of value from one another under real conditions of use, for example on a banknote processing machine, the expected tolerances of the sensor system during measurement also have to be taken into consideration when defining the different classes, in addition to the expected production fluctuations of the luminescence features. This significantly limits the number of code classes able to be reliably separated in practice. Especially in banknote processing, it is customary to check or to sort different banknotes on fast-running banknote processing machines. The processing speeds may be up to 12 m/s here and place considerable demands on the reliable separation of different coding classes.

### SUMMARY

Proceeding from this, the invention is based on the object of specifying a document of value of the type mentioned at the outset, which allows reliable checking or classification of the document of value with a high degree of protection against counterfeiting. The invention is also intended to provide a manufacturing method and a method for checking such documents of value.

According to the invention, the luminescence feature of a generic flat document of value comprises a first luminescence marker in a first subarea and a second luminescence marker in a second, different subarea.

The first and second luminescence markers are able to be excited to luminesce at the same wavelength, hereinafter sometimes also referred to as excitation wavelength, and luminesce, after excitation, essentially in the same emission band in the infrared spectral range. The emission band may preferably be the contiguous wavelength range or the wavelength interval of the emission spectrum around the maximum intensity in the infrared spectral range in which the intensity is greater than 5% of the maximum intensity of the emission spectrum in the infrared spectral range. The emission bands are preferably essentially the same if the emission bands overlap to a degree of more than 90% of the width of the wider emission band.

The first and second luminescence markers have spectrally similar infrared emission spectra, namely infrared emission spectra that have a spectral difference between 0.5% and 15%.

The spectral difference between the emission spectra of the first and second luminescence markers may be given in particular as the maximum of the absolute value of the difference spectrum of the two emission spectra, each normalized to the emission maximum, in the spectral range formed by or comprising the emission bands.

Furthermore, the first and second subareas are arranged so as to overlap one another in the surface area in projection onto the longitudinal direction and/or in projection onto the transverse direction.

In particular, the surface area is identical to the document of value, that is to say the edges of the surface area correspond to the edges of the document of value.

In the case of a rectangular surface area, the longitudinal direction, as is customary, denotes the direction of the longer dimension, and the transverse direction denotes the direction, perpendicular thereto, of the shorter dimension of the surface area. In the case of a square surface area, the dimensions of the longitudinal and transverse directions are the same.

In particular, the document of value may be in the form of a banknote.

However, the document of value may also be one page of a book-like document of value, such as for example a passport. The first and second subareas may be located in particular on the same page of a book-like document of value. The longitudinal direction or transverse direction may designate the direction of the longer or shorter dimension of this page.

The spectral similarity between the two luminescence markers or their infrared emission spectra ensures that environmental influences and/or variations of the sensors used to capture the luminescence emission have the same effect on the measurement of the two luminescence markers and are therefore able to be compensated for well through a differential evaluation.

The small spectral difference between the two emission spectra also leads to an increase in protection against counterfeiting for the document of value, since a potential counterfeiter will only recognize a single luminescence that appears identical when analyzing an original document of value within the scope of measurement accuracy, and will at most attempt to reproduce this single luminescence.

Advantageously, the first and second luminescence markers or their infrared emission spectra have a spectral difference between 1% and 11%, preferably between 2% and 7%.

Expediently, the first and second luminescence markers are able to be excited with a wavelength in the wavelength range of 700 to 2500 nm, preferably in the wavelength range of 900 to 2100 nm. As an alternative or in addition, the first and second luminescence markers are selected such that they luminesce, after excitation, in the wavelength range of 700 to 2500 nm, preferably of 900 to 2100 nm. Preferably, the emission wavelength here is greater than the excitation wavelength, in particular greater by at most 100 nm.

The two luminescence markers advantageously exhibit substantially no upconversion and emit substantially no light, that is to say for example less than 1% of their total emission power, in the visible spectral range, in particular after excitation. The luminescence of the luminescence feature is then not able to be perceived by the naked human eye and constitutes a hidden security feature with a high protective effect.

The first and/or second luminescence marker advantageously contains an organic, organometallic or inorganic luminescent substance. Advantageous examples of such luminescent substances are doped inorganic pigments containing the dopants neodymium and/or ytterbium and/or erbium and/or thulium and/or holmium or doped with certain transition metals such as manganese, for example. Further preferred are organometallic complexes containing neodymium and/or ytterbium and/or erbium or certain organic dyes. Suitable inorganic matrices are for example:

oxides, in particular 3- and 4-valent oxides such as for example titanium oxide, aluminum oxide, iron oxide, boron oxide, yttrium oxide, cerium oxide, zirconium oxide, bismuth oxide, and more complex oxides such as for example garnets, including but not limited to for example yttrium-iron garnets, yttrium-aluminum garnets, gadolinium-gallium garnets; perovskites, including but not limited to yttrium-aluminum perovskite, lanthanum-gallium perovskite; spinels, including but not limited to zinc-aluminum spinels, magnesium-aluminum spinels, manganese-iron spinels; or mixed oxides such as for example ITO (indium tin oxide); oxyhalides and oxychalcogenides, in particular oxychlorides such as for example yttrium oxychloride, lanthanum oxychloride; and oxysulfides, such as for example yttrium oxysulfide, gadolinium oxysulfide; sulfides and other chalcogenides, for example zinc sulfide, cadmium sulfide, zinc selenide, cadmium selenide; sulfates, in particular barium sulfate and strontium sulfate; phosphates, in particular barium phosphate, strontium phosphate, calcium phosphate, yttrium phosphate, lanthanum phosphate, and more complex phosphate-based compounds such as apatites, including but not limited to calcium hydroxylapatites, calcium fluorapatites, calcium chlorapatites; or spodiosites, including for example calcium fluorospodiosites, calcium chlorospodiosites; silicates and aluminosilicates, in particular zeolites such as for example zeolite A, zeolite Y; zeolite-related compounds such as for example sodalites; feldspars such as for example alkaline feldspars, plagioclases; other inorganic compound classes such as for example vanadates, germanates, arsenates, niobates, tantalates.

In one advantageous embodiment, provision is made for the first and second luminescence markers to each contain only a single luminescent substance.

As an alternative, the first and/or second luminescence marker may also contain multiple luminescent substances. The latter makes it possible to easily set very precise differences between the two luminescence markers during production. Provision may be made in particular for the first and second luminescence markers to contain a common luminescent substance and for at least one of the luminescence markers to contain an additional luminescent substance that creates the small spectral difference between the two luminescence markers.

By way of example, the first luminescence marker M₁ may contain only a single luminescent substance A and the second luminescence marker M₂ may be produced by mixing the luminescent substance A with a small amount of an additional luminescent substance ε that slightly changes the emission spectrum of the luminescent substance A. This procedure may be described schematically by M₁=A and M₂=A+ε.

As an alternative, both luminescence markers may contain an additional luminescent substance ε in each case in small but different amounts λ₁, λ₂, that is to say schematically M₁=A+λ₁ ε and M₂=A+λ₂ ε, with λ₁≠λ₂. The two luminescence markers may also each contain a small amount of different luminescent substances ε₁, ε₂, that is to say schematically M₁=A+ε₁ and M₂=A+ε₂.

Different luminescent substances having very similar emission spectra may also be used for the two luminescence markers, this being able to be achieved for example through slightly different process management during manufacture or through a slightly different chemical composition of the starting materials.

In one advantageous embodiment, provision is made for the first and second luminescence markers also to differ, in addition to said spectral difference, in terms of the onset and/or decay times of the emission at one, several or even all emission wavelengths. This further increases the separability of the luminescence markers, and thus the number of possible distinguishable codings.

According to one expedient embodiment, the first and second luminescence markers are each arranged in an ink area printed on the document of value. In particular, the first and second luminescence markers may be present here in visually invisible ink areas. As an alternative, provision may be made for the first and second luminescence markers to be present in visually visible ink areas, advantageously in infrared-transparent ink areas. The latter prevents any absorptions in the ink from interfering with the measurement of infrared luminescence. As an alternative, the combination of a visually invisible ink area and a visually visible ink area is possible as well. This increases freedom in terms of design.

In another embodiment that is likewise advantageous, the first luminescence marker is arranged in an ink area printed on the document of value, while the second luminescence marker is arranged in a security element, in particular a strip or patch, applied to the document of value.

The first and second subareas may be arranged in various ways. Preferably, the first and second subareas are disjunct, that is to say there is no area of overlap in which both the first and the second luminescence marker are present. This simplifies both the manufacture, for example the printing process, and the evaluation of a measurement of the luminescence feature.

In other embodiments, there is an area of overlap in which both luminescence markers are present. However, provision is preferably made in that case for there to also be areas of non-overlap in each subarea, in which only the first or only the second luminescence marker is present alone. Embodiments with areas of overlap allow greater design freedom without giving up the described functionality provided by the areas of non-overlap.

If the first and second subareas are arranged so as to overlap only in projection onto a single direction, then this is preferably the shorter transverse direction. This ensures that the same measuring track of a feature sensor is able to measure both the first luminescence marker in the first subarea and the second luminescence marker in the second subarea when the document of value is transported longitudinally past a conventional short-edge-leading sensor.

Advantageously, the first and second subareas are arranged so as to overlap one another even in projection onto both directions, that is to say longitudinal direction and transverse direction. This has the advantage that the banknote is able to be checked on both longitudinal-measuring and transverse-measuring processing machines, and the same measuring track is able to be used to measure the two luminescence markers in each case. In one advantageous embodiment, the two subareas themselves do not overlap here.

In one advantageous embodiment, the luminescence feature comprises only a single first subarea and only a single second subarea, wherein the first and second subareas are arranged so as to overlap one another in the surface area both in projection onto the longitudinal direction and in projection onto the transverse direction.

As an alternative, the first and/or second subarea may also each consist of multiple non-contiguous subareas.

In one advantageous concrete embodiment, the luminescence feature forms a barcode the bar elements of which are formed by subareas having different luminescence markers. The barcode may be one-dimensional, multi-line or even two-dimensional. If A designates a first luminescence marker and B designates a second luminescence marker, then the subareas may be formed for example in the form ABA, ABBA, ABBAB, etc. In the case of multi-line barcodes, the same luminescence marker A is advantageously used as a reference marker in each line.

A one-dimensional or multi-line barcode may be formed in particular by a plurality of, for example three different luminescence markers A, B, C, wherein one of the luminescence markers, for example the luminescence marker A, is used as a reference marker for the precise measurement of the spectral signatures of the other luminescence markers B and C. In the case of a multi-line barcode, the same luminescence marker A is advantageously used as a reference marker in each line. In this case, for example, only two different luminescence markers may also be used per line, that is to say for example the luminescence markers A and B in even lines and the luminescence markers A and C in odd lines.

In all designs, provision may advantageously be made for the luminescence feature, in addition to the first and second subareas, to comprise at least one third subarea different from the first and second subareas and having a third luminescence marker having a spectrally similar infrared emission spectrum to the first and in particular also the second luminescence marker, with a spectral difference between 0.5% and 15%. It goes without saying that further subareas having further luminescence markers may also be provided in the same way.

The invention also includes a document of value system consisting of a plurality of different documents of value of the type described, in which the documents of value of the document of value system each all have the same luminescence marker in the first subarea and different luminescence markers in the second subarea. The luminescence marker in the first subarea serves as a common reference marker, and the different luminescence markers in the second subarea are used to check and/or classify the documents of value.

By way of example, the document of value system may contain the various banknotes in a series containing multiple different denominations. Banknotes of different denominations contain different luminescence markers in the second subarea, but the same reference marker in the first subarea. The differential measurement makes it possible to distinguish the banknotes of different denominations reliably from one another, despite the spectral similarity between the luminescence markers of the respective second subareas.

The invention also includes a method for manufacturing a flat document of value of the type described, in which a document of value substrate having a surface area extending in a longitudinal direction and a transverse direction is provided.

The document of value substrate is provided with a luminescence feature in the surface area by arranging a first luminescence marker in a first subarea and a second luminescence marker in a second, different subarea in the surface area such that the first and second subareas overlap one another in projection onto the longitudinal direction and/or in projection onto the transverse direction.

The first and second luminescence markers are able to be excited here to luminesce at the same wavelength and luminesce, after excitation, essentially in the same emission band in the infrared spectral range. Furthermore, the first and second luminescence markers have spectrally similar infrared emission spectra, namely infrared emission spectra that have a spectral difference between 0.5% and 15%.

In one advantageous method implementation, the first and second luminescence markers are printed on the document of value substrate, preferably using different printing methods. Advantageous printing methods able to be used here are in particular offset printing, intaglio printing, engraving, numerical printing, flexographic printing, or screen printing.

In a further advantageous method implementation, the first and second luminescence markers are printed on the document of value substrate using the same printing method.

In another, likewise advantageous method implementation, the first luminescence marker is printed on the document of value substrate. The second luminescence marker is arranged in a security element, in particular a strip or patch, and the security element having the second luminescence marker is applied to the document of value substrate or introduced into the document of value substrate.

Finally, the invention also includes a method for checking a flat document of value of the type described, in which the luminescence emissions of the two luminescence markers of the first and second subareas are captured together or the flat document of value is transported and, while it is being transported, the luminescence emissions of the two luminescence markers of the first and second subareas are captured by way of a sensor, and in which the spectral properties of the second luminescence marker are evaluated relative to the spectral properties of the first luminescence marker. Depending on the result of the evaluation, an authenticity signal, representing the result of the evaluation, may then be formed and output. In order to capture the luminescence emissions, the subareas are excited with excitation radiation of the excitation wavelength from a radiation source. The radiation source may preferably be part of the sensor.

The luminescence emissions of the two luminescence markers are advantageously captured together in that the luminescence emissions of the two luminescence markers are captured in direct succession, for example while the document of value is being transported continuously past a sensor, along a measuring track that covers both subareas. The measuring track is advantageously oriented parallel to the longitudinal direction or to the transverse direction of the surface area. In the method, in particular, the document of value may thus be transported parallel to the longitudinal direction or to the transverse direction of the document of value.

Advantageously, the luminescence emission of the two luminescence markers is captured using a single-track or multi-track luminescence sensor having at least two spectral channels. Said sensor may to this end comprise a single-track or multi-track luminescence sensor having at least two spectral channels.

### BRIEF DESCRIPTION OF THE DRAWINGS

Further exemplary embodiments and advantages of the invention will be explained below on the basis of the figures, the representation of which dispenses with reproduction that is to scale and in proportion in order to increase clarity.

In the figures

FIG. 1 shows a schematic illustration of a banknote extending in a surface area having a longitudinal direction L and a transverse direction Q,

FIG. 2, including FIGS. 2(a) and 2(b), shows, in 2(a), the emission spectra of the first and second luminescence markers and, in 2(b), the difference spectrum of the two emission spectra,

FIG. 3, including FIGS. 3(a) and 3(b), shows, in 3(a), the emission spectra and, in 3(b), the associated difference spectrum for another combination of two luminescence markers,

FIGS. 4 and 5, including FIGS. 4(a) and 4(b) and FIGS. 5(a) and 5(b), each show, in 4 (a) and 5(a), the emission spectra and, in 4(b) and 5(b), the associated difference spectrum for further combinations of two luminescence markers,

FIG. 6 shows a schematic illustration of a banknote with a different configuration of the subareas having spectrally similar luminescence markers,

FIG. 7, including FIGS. 7(a) to 7(c) shows further arrangements of the subareas having spectrally similar luminescence markers in a surface area,

FIG. 8, including FIGS. 8(a) and 8(b), shows, in 8(a), two reference banknotes having two luminescence markers and, in 8(b), a histogram containing the number of measurement results plotted against spectral position,

FIG. 9, including FIGS. 9(a) and 9(b), shows, in 9(a), two banknotes having two luminescence markers and a reference marker and, in 9(b), a histogram containing the number of measurement results plotted against relative spectral position,

FIG. 10 shows a schematic illustration of an apparatus for checking the banknote in FIG. 1, and

FIG. 11 shows a rough schematic flowchart of a method for checking the banknote in FIG. 1 by way of the apparatus in FIG. 10.

### DETAILED DESCRIPTION OF VARIOUS EMBODIMENTS

The invention is now explained using the example of checking the authenticity of banknotes. FIG. 1 to this end shows a schematic illustration of a banknote 10, which has a surface area having a longitudinal direction L and a transverse direction Q. The banknote 10 is provided, in the surface area, with a luminescence feature 12, which contains a first luminescence marker in a first subarea 14 and a second luminescence marker in a second subarea 16.

In the exemplary embodiment of FIG. 1, the first and second subareas 14, 16 are disjunct, that is to say have no overlap, but rather are arranged spaced apart from one another in the surface area. It is essential here that the two subareas 14, 16 are arranged in the surface area such that they overlap one another in projection onto the transverse direction Q of the banknote 10. The projection 14-P of the subarea 14 and the projection 16-P of the subarea 16 onto the transverse direction Q are shown on the right in FIG. 1. As may be seen, the two projections 14-P, 16-P overlap in an area of overlap 18.

This ensures that, when the banknote 10 is scanned in a checking device along a measuring track 20 in the longitudinal direction L by the feature sensor, both the subarea 14 having the first luminescence marker and the subarea 16 having the second luminescence marker are covered successively a short time apart.

The luminescence markers of the subareas 14, 16 are able to be excited here at the same wavelength or excitation wavelength and luminesce, after excitation, essentially in the same emission band in the infrared spectral range. The emission bands are each given by the contiguous wavelength range or the wavelength interval of the emission spectrum around the maximum intensity in the infrared spectral range in which the intensity is greater than 5% of the maximum intensity of the emission spectrum in the infrared spectral range. As will be explained in more detail below, the luminescence markers are coordinated such that their emission spectra are spectrally very similar to one another and are affected in the same way by the ambient conditions and the measurement conditions. By directly comparing the emissions of the two luminescence markers during a measurement using the same detector or sensor along the same measuring track, it is thereby possible to reliably recognize and separate even subtle differences between the two spectra that are usually not able to be detected due to fluctuation of the measurement signal in different structurally identical detectors, different measuring tracks or due to different ambient conditions.

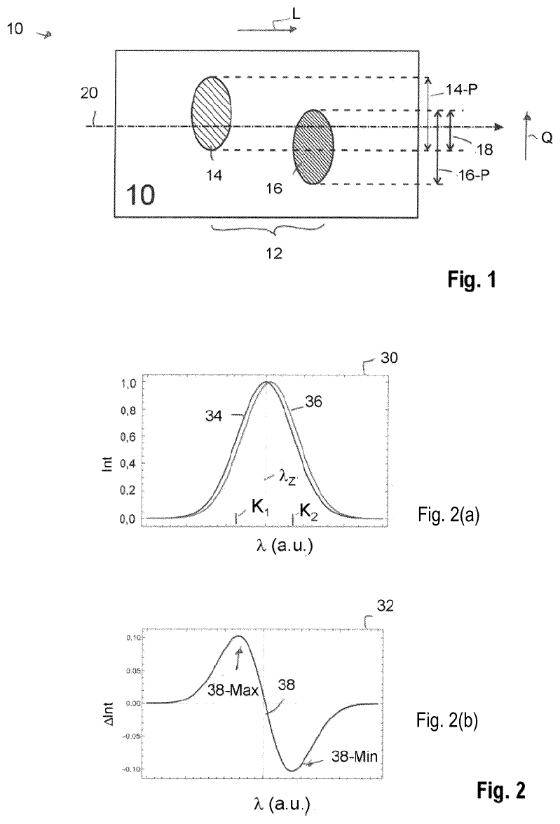

For a more detailed explanation, the graph 30 of FIG. 2(a) shows the emission spectrum 34 of the first luminescence marker of the first subarea 14 and the emission spectrum 36 of the second luminescence marker of the second subarea 16, each plotted as an intensity normalized to the emission maximum against wavelength in arbitrary units. As may be seen from the figure, the emission spectra 34, 36 are very similar to one another; the emission maximum of the spectrum 36 of the second luminescence marker is just slightly shifted with respect to the emission maximum of the spectrum 34 of the first luminescence marker.

In order to be able to quantify the spectral similarity, the graph 32 of FIG. 2(b) shows the difference spectrum 38 of the two emission spectra 34, 36, which has a maximum and a minimum due to the mutually shifted peak wavelength of the two spectra. In this description, the spectral difference between two emission spectra 34, 36 is defined for example as the maximum of the absolute value of the difference spectrum 38 of the emission spectra normalized to the emission maximum, expressed in percent. In the exemplary embodiment of FIG. 2, the maximum absolute value of the difference spectrum 38 at the locations of the maximum 38-Max and the minimum 38-Min is 0.1 in each case, and so the spectral difference between the two emission spectra is 10%.

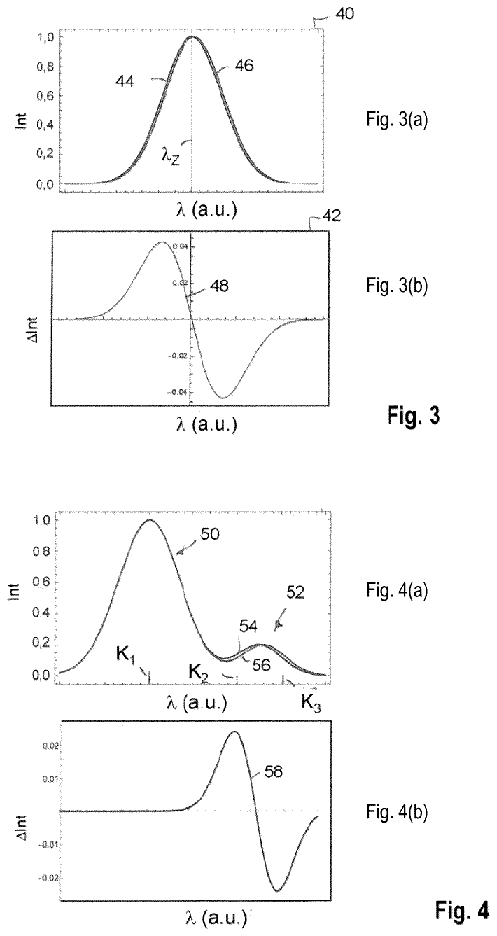

FIG. 3 illustrates the emission spectra of another combination of a first and second luminescence marker with an even smaller mutual shift in the peak wavelengths of the emission spectra in the case of excitation with the excitation wavelength, in an illustration as in FIG. 2. The graph 40 of FIG. 3(a) here shows the emission spectrum 44 of the first luminescence marker and the emission spectrum 46 of the second luminescence marker, and the graph 42 of FIG. 3(b) shows the difference spectrum 48 of the two emission spectra 44, 46. The maximum of the absolute value of the difference spectrum 48 for these two luminescence markers is only 0.043, and the spectral difference between the two emission spectra is thus 4.3%.

FIG. 4 shows, in the same illustration, the emission spectra of a further combination of two luminescence markers, which exhibit an identical main emission 50 and differ only in terms of the position of the maximum of the secondary emission 52. FIG. 4(a) shows the emission spectrum 54 of a first luminescence marker and the emission spectrum 56 of a second luminescence marker, and FIG. 4(b) shows the difference spectrum 58 of the two emission spectra 54, 56. Due to the identical main emission 50 of the two luminescence markers, the difference spectrum 58 deviates significantly from zero only in the region of the secondary emission 52, and exhibits a maximum deviation, in terms of absolute value, of the two spectra of 0.024, that is to say a spectral difference of 2.4%.

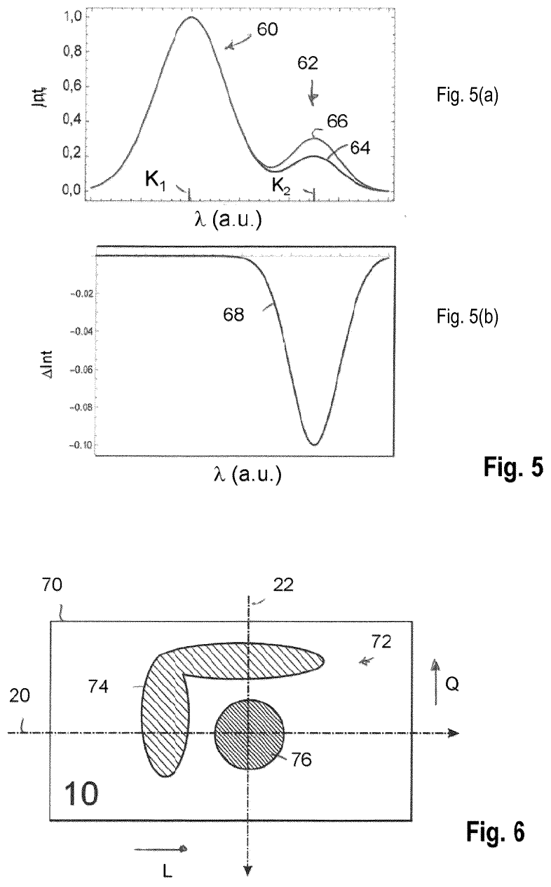

A further variant is illustrated in FIG. 5, in which the emission spectra of two luminescence markers are shown, exhibiting an identical main emission 60 but a secondary emission 62 of different intensity.

FIG. 5(a) shows the emission spectrum 64 of the first luminescence marker and the emission spectrum 66 of the second luminescence marker. Intensity Int is plotted on the ordinate and wavelength λ is plotted on the abscissa.

FIG. 5(b) shows the difference spectrum 68 of the two emission spectra 64, 66. In this case too, due to the identical main emission 60, the difference spectrum 68 deviates significantly from zero only in the region of the secondary emission 62, and exhibits a maximum deviation, in terms of absolute value, of the two spectra of 0.1, that is to say a spectral difference of 10%.

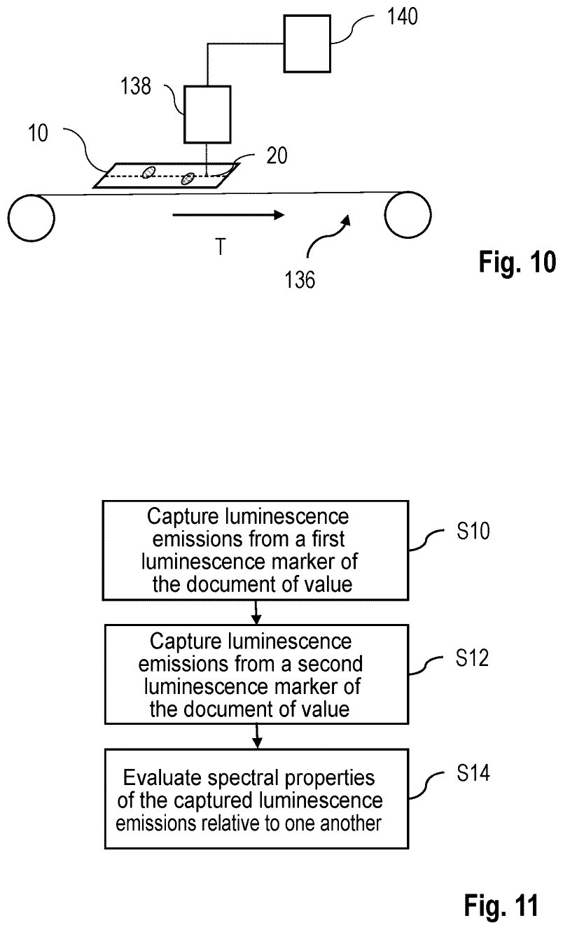

To check the banknote 10, the apparatus illustrated in FIG. 10 may be used to check flat documents of value. This apparatus may be part of a device, not shown, for processing documents of value. This comprises a transport apparatus 136 for transporting a document of value 10 in a transport direction T past a sensor 138 for capturing luminescence emissions from the document of value 10. The sensor 138, in the example a luminescence sensor, is designed to capture luminescence emissions of the document of value 10, in the example of the banknote in FIG. 1, and to form detection signals that reflect the properties, in particular spectral properties, of the captured luminescence emissions. An evaluation apparatus 140 is connected to the sensor 138 via a signal connection and processes detection signals formed by the sensor 138 while the document of value is being transported past the same sensor 138.

The sensor 138 comprises in particular a radiation source for outputting radiation of the excitation wavelength to a document of value to be checked, and a detector for the spectrally resolved capturing of the luminescence emissions generated by excitation with the excitation radiation.

To check a document of value 10, for example the banknote 10 in FIG. 1, this is transported past the sensor 138 by way of the transport apparatus 136. In this example, the document of value is aligned relative to the transport apparatus such that the longitudinal side of the document of value runs parallel to the transport direction T in which the document of value 10 is transported.

The following steps of a method for checking the document of value are carried out.

In step S10, the sensor 138 is used to capture at least one luminescence emission of the luminescence marker in the first subarea, since this is the first to enter a coverage area of the sensor 138. This results in the formation of first detection signals that reflect spectral properties of the captured luminescence emission. Said signals are supplied to the evaluation apparatus 140.

In step S12, the sensor 138, that is to say the same sensor, is used to capture at least one luminescence emission of the luminescence marker in the second subarea, since this enters the coverage area of the sensor 138 after the first subarea. This results in the formation of second detection signals that reflect spectral properties of the captured luminescence emission. Said signals are likewise supplied to the evaluation apparatus 140.

In step S14, the spectral properties of the emission of the first luminescence marker or of the first luminescence marker relative to the spectral properties of the emission of the second luminescence marker or of the second luminescence marker are then evaluated by the evaluation apparatus 140 using the supplied first and second detection signals. Depending on the result of the evaluation, an authenticity signal, representing the result of the evaluation, is then formed and output. The authenticity signal may be output to an apparatus that controls the further processing of the document of value.

In addition to a design as in FIG. 1, in which exactly two disjunct subareas 14, 16 having spectrally similar luminescence markers overlap one another only in projection onto the transverse direction, other embodiments are also possible and advantageous. By way of example, with reference to FIG. 6, the luminescence feature 72 of a banknote 70 may contain a first subarea 74 and a disjunct second subarea 76, wherein the subareas 74, 76 overlap one another both in projection onto the longitudinal direction L and in projection onto the transverse direction Q of the banknote 70.

Both subareas 74, 76 may thereby each be covered by a feature sensor when the banknote is scanned both along a measuring track 20 in the longitudinal direction and along a measuring track 22 in the transverse direction, such that the banknote 70 is able to be checked both in longitudinal-measuring and in transverse-measuring banknote processing machines.

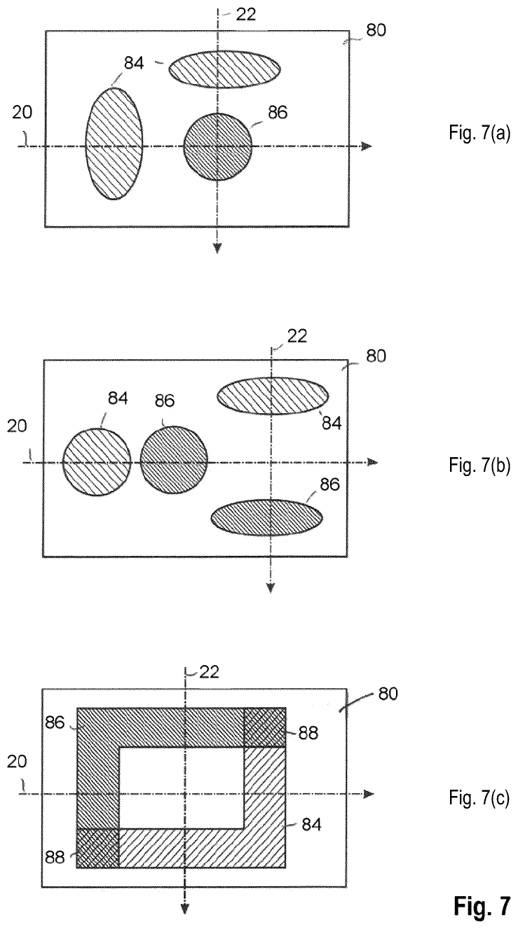

Further advantageous arrangements of the subareas having spectrally similar luminescence markers are illustrated in FIG. 7. In this case, FIG. 7(a) shows the surface area 80 of a document of value having multiple spaced-apart first subareas 84 having a first luminescence marker and having a single second subarea 86 having a second luminescence marker. In this case too, measuring tracks 20, 22 capture both a first and a second subarea in the longitudinal and transverse direction, respectively, such that the document of value having the surface area 80 is able to be checked both with a longitudinal measurement and with a transverse measurement.

The same effect may be achieved with a design according to FIG. 7(b), in which the surface area 80 has a plurality of spaced-apart first subareas 84 having a first luminescence marker and a plurality of spaced-apart second subareas 86 having a second luminescence marker. The measuring tracks 20, 22 capture both a first and a second subarea in the longitudinal and transverse direction, respectively.

In other designs, the first and second subareas are not disjunct, but rather are formed so as to overlap in regions, as shown in FIG. 7(c). In this embodiment, the surface area 80 contains a first subarea 84 having a first luminescence marker and a second subarea 86 having a second luminescence marker, which overlap one another in the areas of overlap 88. It is essential here that there are also areas of non-overlap in which only the first or only the second luminescence marker is present alone. As may be seen in FIG. 7(c), the measuring tracks 20, 22 respectively capture areas of non-overlap of the first and second subareas 84, 86 in the longitudinal and transverse direction, and therefore, as in the designs described up to now, allow a differential evaluation of the measurement signals.

In order to demonstrate the advantages of the invention, a luminescence measurement on banknotes according to the invention was compared with a corresponding measurement on reference banknotes having conventional luminescence features.

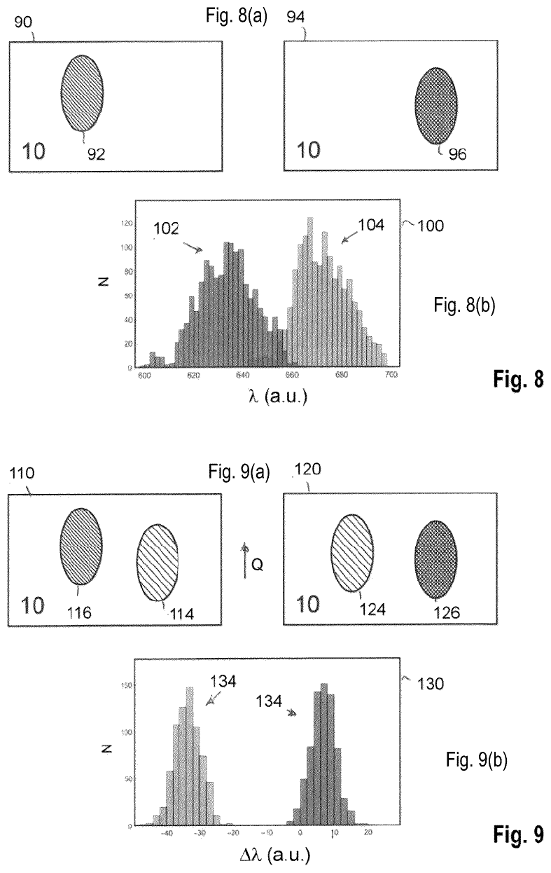

First of all, FIG. 8(a) shows two reference banknotes 90, 94 on each of which an infrared-excitable luminescence marker that luminesces in the infrared was printed in a respective subarea 92 and 96. The subarea 92 of the first reference banknote 90 contains a luminescence marker “B”, and the subarea 96 of the second reference banknote 94 contains a luminescence marker “C”, wherein the spectral difference between the two luminescence markers is 3%.

In order to simulate a banknote check under real conditions of use, the reference banknotes 90, 94 were measured using three structurally identical feature sensors at multiple transport speeds between 1 m/s and 11 m/s and at multiple measurement points within the respective subarea 92, 96, and a measure of the spectral position, for example the spectral centroid of a local emission maximum or of an emission band of the luminescence emission of the two luminescence markers, was determined from the measured values. Instead of the spectral centroid of an emission band, for example, the wavelength of the emission maximum or else the wavelength of another spectral feature, for example a secondary maximum, a minimum or a shoulder in the emission spectrum, may also be used as a measure of the spectral position.

FIG. 8(b) shows, in a histogram 100, the number N of measurement results, plotted against the respectively determined spectral position for the two luminescence markers “B” and “C”. As may be seen from the figure, the distributions 102, 104 of the spectral positions determined for the two luminescence markers have a non-negligible overlap, and so it is not possible to reliably distinguish the two luminescence markers due to the size of the fluctuations that occur. Such fluctuations may be caused for example by variations between the nominally structurally identical sensors, or variations in ambient conditions, such as temperature, transport distance, or transport speed.

FIG. 9(a) shows two banknotes 110, 120 according to the invention, which may for example be part of an abovementioned document of value system. In addition to the abovementioned luminescence markers “B” and “C”, the banknotes 110, 120 each contain a further luminescence marker “A” as a reference marker. The emission spectrum of the luminescence marker “A” lies between the emission spectra of the luminescence markers “B” and “C”, and is therefore spectrally similar to both luminescence markers, with a spectral difference of around 0.5% and around 3%, respectively.

Specifically, the banknote 110, in a configuration as in FIG. 1, has the luminescence marker “A” printed on it in a first subarea 114 and has the luminescence marker “B” of the reference banknote 90 printed on it in a second subarea 116. The two subareas 114, 116 overlap here in projection onto the transverse direction Q, and are both able to be captured with a measuring track.

The banknote 120, in a configuration as in FIG. 1, likewise has the luminescence marker “A” printed on it in a first subarea 124 and has the luminescence marker “C” of the reference banknote 94 printed on it in a second subarea 126. In this case too, the two subareas 124, 126 overlap in projection onto the transverse direction Q, and are both able to be captured with a measuring track.

The banknotes 110, 120 according to the invention were then measured using the same three structurally identical feature sensors and at the same transport speeds between 1 m/s and 11 m/s as the reference banknotes at multiple measurement points within the respective subareas 114, 116 and 124, 126.

In the process, the spectral position of the luminescence emission of the second subarea 116 of the banknote 110 having the luminescence marker “B” and the second subarea 126 of the banknote 120 having the luminescence marker “C” were not determined in absolute terms, but rather relative to the luminescence emission of the luminescence marker “A” of the respective first subarea 114 and 124.

FIG. 9(b) shows, in a histogram 130, the number N of measurement results obtained, plotted against the respectively determined spectral position of the two luminescence markers “B” and “C” relative to the spectral position of the luminescence marker “A” (zero point in FIG. 9(b)).

Since the fluctuations that occur during the measurement, such as variations between the three nominally structurally identical sensors (for instance filter tolerances or optical tolerances) or variations in ambient conditions (for instance temperature, transport distance, transport speed) affect the measurement of the spectral position of the two subareas 114 and 116, respectively 124 and 126, in the same way, these fluctuations largely compensate for one another in a differential evaluation, and considerably smaller distribution widths result in the histogram 130 of the relative spectral position. As shown in FIG. 9(b), the distributions 132, 134 of the differential measurement results for the luminescence markers “B” and “C” are clearly separated from one another, and the two luminescence markers are able to be reliably distinguished based on their relative spectral position.

Documents of value according to the invention may be checked in particular using a single-track or multi-track luminescence sensor having at least 2 spectral channels K1, K2 that is able, using these spectral channels, to detect the differences between the luminescence markers used on a document of value. Advantageously, the two spectral channels capture closely adjacent or even directly adjacent spectral ranges of the emission spectra. If for example the emission band of the two luminescence markers lies spectrally approximately centrally between the spectral sensitivity ranges of the two spectral channels, then small shifts of the peak wavelength are able be determined with high precision.

By way of example, in the emission spectra 34, 36 of FIG. 2, it is possible to select a spectral channel at position K1 below the center wavelength λ_{z} and a second spectral channel at position K2 above the center wavelength λ_{z} at the same distance from the center wavelength. It is advantageously also possible to use spectral channels having a width of several nanometers, for example between 2 and 50 nanometers.

In another design, multiple spectral channels, for example 4, 10, 20 or even 100 spectral channels are used to be able to accurately sample the shape of the emission spectra.

In another variant, the spectral channels of a luminescence sensor are adapted to certain more complex emission spectra, such that individual peaks of the emission spectra are able to be detected using a few different channels. By way of example, in the emission spectra 54, 56 of FIG. 4, it is possible to use a feature sensor having three spectral channels that capture the luminescence emission at the wavelength positions indicated in the figure, namely, on the one hand, in the region of the maximum of the main emission 50 at position K1 and, on the other hand, symmetrically on both sides of the maximum of the secondary emission 52 at the positions K2 and K3.

In the emission spectra 64, 66 of FIG. 5, a feature sensor having two spectral channels is sufficient, using which it is possible to capture the luminescence emission in the region of the maximum of the main emission 60 at position K1 and in the region of the maximum of the secondary emission 62 at position K2.

1.-22. (canceled)

23. A flat document of value, which has a surface area having a longitudinal direction and a transverse direction and which is provided with a luminescence feature in the surface area, wherein
the luminescence feature comprises a first luminescence marker in a first subarea and a second luminescence marker in a second, different subarea,
the first and second luminescence markers are able to be excited to luminesce at the same wavelength and luminesce, after excitation, essentially in the same emission band in the infrared spectral range,
the first and second luminescence markers have spectrally similar infrared emission spectra, namely infrared emission spectra that have a spectral difference between 0.5% and 15%, and
the first and second subarea are arranged so as to overlap one another in the surface area in projection onto the longitudinal direction and/or in projection onto the transverse direction.

24. The flat document of value according to claim 23, wherein the first and second luminescence markers have a spectral difference between 1% and 11%.

25. The flat document of value according to claim 23, wherein the first and second luminescence markers are able to be excited with a wavelength in the wavelength range of 700 to 2500 nm, and/or in that the first and second luminescence markers luminesce, after excitation, in the wave-length range of 700 to 2500 nm.

26. The flat document of value according to claim 23, wherein the first and second luminescence markers exhibit substantially no upconversion, arranged to emit substantially no light in the visible spectral range after excitation.

27. The flat document of value according to claim 23, wherein the first and/or second luminescence marker contains an organic, organometallic or inorganic luminescent substance.

28. The flat document of value according to claim 23, wherein the first and second luminescence markers each contain only a single luminescent substance.

29. The flat document of value according to claim 23, wherein the first and second luminescence markers contain a common luminescent substance and at least one of the luminescence markers contains an additional luminescent substance.

30. The flat document of value according to claim 23, wherein the first and second luminescence markers differ in terms of the onset and/or decay times of the emission at one, several or all emission wavelengths.

31. The flat document of value according to claim 23, wherein the first and second luminescence markers are each arranged in an ink area printed on the document of value, in that the first and second luminescence markers are present in visually invisible ink areas, or in that the first and second luminescence markers are present in visually visible ink areas, in infrared-transparent ink areas.

32. The flat document of value according to claim 23, wherein the first luminescence marker is arranged in an ink area printed on the document of value and the second luminescence marker is arranged in a security element, applied to the document of value.

33. The flat document of value according to claim 23, wherein the first and second subareas are disjunct.

34. The flat document of value according to claim 23, wherein the luminescence feature comprises only a single first subarea and only a single second subarea, and in that the two subareas are arranged so as to overlap one another in the surface area both in projection onto the longitudinal direction and in projection onto the transverse direction.

35. The flat document of value according to claim 23, wherein the luminescence feature forms a barcode the bar elements of which are formed by subareas having different luminescence markers.

36. The flat document of value according to claim 23, wherein the luminescence feature comprises at least one third, different subarea having a third luminescence marker that has a spectrally similar infrared emission spectrum to the first and second luminescence markers, with a spectral difference between 0.5% and 15%.

37. A document of value system consisting of a plurality of different documents of value according to claim 23, in which the documents of value of the document of value system each all have the same luminescence marker in the first subarea and different luminescence markers in the second subarea.

38. A method for manufacturing a flat document of value according to claim 23, in which a document of value substrate having a surface area extending in a longitudinal direction and a transverse direction is provided and is provided with a luminescence feature in the surface area by arranging a first luminescence marker in a first subarea and a second luminescence marker in a second, different subarea in the surface area such that the first and second subareas overlap one another in projection onto the longitudinal direction and/or in projection onto the transverse direction,
wherein the first and second luminescence markers are able to be excited to luminesce at the same wavelength and luminesce, after excitation, essentially in the same emission band in the infrared spectral range, and
wherein the first and second luminescence markers have spectrally similar infrared emission spectra, namely infrared emission spectra that have a spectral difference between 0.5% and 15%.

39. The method according to claim 38, wherein the first and second luminescence markers are printed on the document of value substrate, using different printing methods.

40. The method according to claim 38, wherein the first luminescence marker is printed on the document of value substrate and the second luminescence marker is arranged in a security element, and the security element having the second luminescence marker is applied to the document of value substrate or introduced into the document of value substrate.

41. A method for checking a flat document of value according to claim 23, in which
the flat document of value is transported and, while it is being transported, the luminescence emissions of the two luminescence markers of the first and second subareas are captured, or the luminescence emissions of the two luminescence markers of the first and second subareas are captured together, by way of a sensor, and
the spectral properties of the second luminescence marker are evaluated relative to the spectral properties of the first luminescence marker.

42. The method according to claim 41, wherein the luminescence emissions of the two luminescence markers are captured together by capturing the luminescence emissions of the two luminescence markers in direct succession along a measuring track that covers both sub-areas.

43. The method according to claim 42, wherein the measuring track is oriented parallel to the longitudinal direction or to the transverse direction of the surface area or the document of value is transported parallel to the longitudinal direction or to the transverse direction of the document of value.

44. The method according to claim 23, wherein the luminescence emission of the two luminescence markers is captured using a single-track or multi-track luminescence sensor having at least two spectral channels, or in that the sensor comprises a single-track or multi-track luminescence sensor having at least two spectral channels.
